(19) United States
(12) Patent Application Publication
(10) Pub. No.: US 2012/0277943 A1
(43) Pub. Date: Nov. 1, 2012

(54) OPTIMIZED VEHICLE TRACTION CONTROL

(75) Inventor: Sang Joon Kim, Seoul (KR)

(73) Assignee: HYUNDAI MOTOR COMPANY, Seoul (KR)

(21) Appl. No.: 13/311,703

(22) Filed: Dec. 6, 2011

(30) Foreign Application Priority Data
Apr. 29, 2011 (KR) 10-2011-0040847

(51) Int. Cl. G06F 7/00; B60W 10/08; B60W 20/00; B60W 10/06

(52) U.S. Cl. 701/22; 903/903

(57) ABSTRACT

In one embodiment, a vehicle motor controller controls an electric drive motor that transfers a torque to a drive wheel, and a traction control system (TCS) controller performs a TCS control to i) reduce a torque transferred to the drive wheel such that the drive wheel does not slip, when it is determined that the drive wheel slips, and ii) release the TCS control to gradually increase the motor torque transferred to the drive wheel along a predetermine line, when it is determined that the drive wheel does not slip. Also, when the TCS is released, the motor torque of the motor may be gradually increased along a predetermined slope such that the drive wheel slip decreases and vibration of the drive system is reduced in the vehicle. Vibration of the drive system may also be decreased through an active damping torque applied against the speed vibration of the motor.

### CROSS-REFERENCE TO RELATED APPLICATION

This application claims priority to and the benefit of Korean Patent Application No. 10-2011-0040847 filed in the Korean Intellectual Property Office on Apr. 29, 2011, the entire contents of which are incorporated herein by reference.

### BACKGROUND OF THE INVENTION

(a) Field of the Invention

The present invention relates to a vehicle that uses a traction control system (TCS) controller to reduce a slip amount so as to improve driving stability in a case that a drive wheel slips on a road while a vehicle is operated.

(b) Description of the Related Art

A hybrid vehicle efficiently combines different types of power sources to drive a vehicle, and most of the hybrid vehicles use an engine that generates a torque by combusting a fuel (gasoline, fossil fuel) and an electric motor that generates a torque through a battery power. The hybrid vehicle is a vehicle that uses an electric motor as well as an engine to reduce exhaust gas and enhance fuel consumption. on the hybrid vehicle have been actively pursued so as to satisfy the needs of the times that must develop eco-friendly products and improve fuel consumption efficiency.

In the hybrid vehicle, an engine, an electric drive motor, and an automatic transmission are arranged in line, as an example. Particularly, an engine clutch is interposed between the engine and the drive motor to be able to deliver power, and the drive motor and the automatic transmission are directly connected. Also, an integrated starter-generator (i.e., outputting a cranking torque) is disposed to apply a starting torque to the engine, and wherein the ISG (Integrated starter and generator) is connected to the engine. In this configuration, if the engine clutch is opened, a drive shaft is rotated by a drive motor, and if the engine clutch is closed, the drive shaft is rotated by the engine and the drive motor.

A driving torque is typically generated only by a drive motor while the vehicle starts or runs in a low speed. That is, because the efficiency of the engine is lower than that of the drive motor, it is advantageous that the drive motor is used to start the vehicle in an aspect of fuel consumption efficiency. After the vehicle “runs” (increases speed), the ISG starts the engine, and the vehicle simultaneously uses the engine output and the motor output.

As stated above, the hybrid vehicle runs based on an EV (electric vehicle) mode that uses only a torque of the drive motor and an HEV (hybrid electric vehicle) mode that uses a torque of the engine as a main power and a torque of the drive motor as a auxiliary power so as to drive the hybrid vehicle, wherein the EV mode is changed to the HEV mode by an engine starting through the ISG.

The mode change between the EV mode and the HEV mode is an important function in the hybrid vehicle, wherein the mode change affects drivability, fuel consumption, and a drive power performance of the hybrid vehicle. Particularly, more accurate mode change control is necessary in the hybrid system including an engine, a drive motor, an automatic transmission, an ISG, and a clutch, wherein the optimized mode change algorithm is necessary.

Meanwhile, a TCS (traction control system) forms a brake hydraulic pressure or reduces an output torque (acceleration torque) to minimize a slip of a drive wheel while a drive wheel is slipped, e.g., on a slippery road. When a slip of the drive wheel is detected, the TCS controller controls the hydraulic pressure of the brake and the output torque of the motor, if the slip amount of the drive wheel decreases to be a value lower than a predetermined value, the TCS control is released. When the TCS control is released, the output torque of the motor is abruptly increased such that the drive wheel may instantly slip or else the drivetrain is vibrated.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a vehicle that performs a TCS control and the control method thereof having advantages of reducing a slip of a drive wheel and a vibration of a drive train that are generated while an output torque of a motor is recovered after a TCS control is released, when a slip amount of a drive wheel decreases to a predetermined value.

A vehicle according to an exemplary embodiment of the present invention may include a motor controller that controls an electric drive motor that transfers a torque to a drive wheel, and a TCS controller that performs a TCS control to i) reduce a torque transferred to the drive wheel such that the drive wheel does not slip, if it is determined that the drive wheel slips on the road, and ii) release the TCS control to gradually increase the motor torque transferred to the drive wheel along a predetermine line, if it is determined that the drive wheel does not slip on the road.

The vehicle may further include an internal combustion engine that selectively transfers a torque to the drive wheel.

The drive motor may transfer a torque to the drive wheel together with the internal combustion engine.

The vehicle may further include an electricity-charged battery, wherein the drive motor may use the electricity of the battery to transfer the torque to the drive wheel.

The battery may be charged by the internal combustion engine.

The battery may be a fuel cell.

The TCS controller may detect a rotation speed of the motor to calculate a speed vibration while the torque that is transferred from the motor to the drive wheel is increased and the motor controller may make the motor generate an active damping torque in an opposite direction of the speed vibration.

A control method of a vehicle according to an exemplary embodiment of the present invention may include determining whether a drive wheel slips on a road, performing a TCS control, if it is determined that the drive wheel slips on the road, and releasing the TCS control, if it is determined that the drive wheel does not slip on the road, while gradually increasing the output torque that is transferred from the motor to the drive wheel.

The control method of a vehicle may further include calculating a speed vibration by using a rotation speed of the motor, and performing an active damping mode that decreases the speed vibration by forming the output torque of the motor in an opposite direction against the speed vibration.

As stated above, when the TCS is released, the motor torque of the motor is gradually increased along a predetermined slope such that the slip of the drive wheel decreases and the vibration of the drive system is reduced in the vehicle according to the present invention.

Further, when the TCS control is released, an active damping torque is applied against the speed vibration of the motor so as to reduce the speed vibration of the motor such that the vibration of the drive system is quickly decreased.

### BRIEF DESCRIPTION OF THE DRAWINGS

FIG. 1 is a schematic diagram of a vehicle according to an exemplary embodiment of the present invention.

FIG. 2 is a flowchart for controlling a vehicle according to an exemplary embodiment of the present invention.

FIG. 3 is a graph for explaining a TCS control of a vehicle according to an exemplary embodiment of the present invention.

FIG. 4 is a diagram showing a method for extracting a vibration element of a motor in a vehicle according to an exemplary embodiment of the present invention.

FIG. 5 is a graph showing procedures for extracting a speed vibration of a motor in a vehicle according to an exemplary embodiment of the present invention.

### DETAILED DESCRIPTION OF THE EMBODIMENTS

An exemplary embodiment of the present invention will hereinafter be described in detail with reference to the accompanying drawings.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

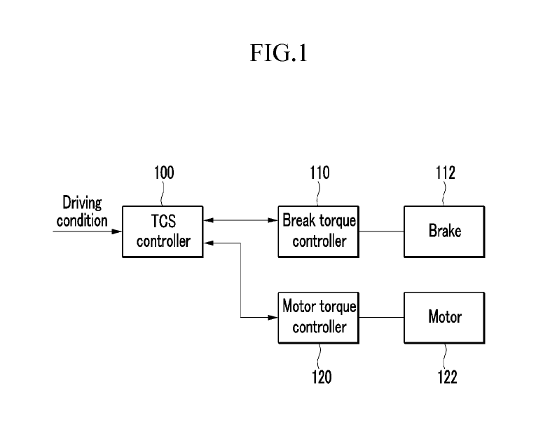

FIG. 1 is a schematic diagram of a vehicle according to an exemplary embodiment of the present invention.

Referring to FIG. 1, the vehicle includes a TCS controller 100, a brake torque controller 110, and motor torque controller 120, wherein the brake controller 110 controls the brake 112 and the motor controller 120 controls the motor 122.

The TCS controller 100 detects driving conditions of the vehicle, where if the slip of the drive wheel (tire) is detected through the vehicle speed and the rotation speed of the drive wheel, the TCS controller controls the brake controller 110 and the motor controller 120 so as to reduce the slip of the drive wheel. Preventing the slip of the drive wheel in this way can be called a TCS control.

If the TCS control is performed, the brake controller 110 operates the brake 112 to output a predetermined brake force so as to prevent the slip of the drive wheel or the motor controller 120 or the motor controller 120 operates the motor 122 to reduce the motor torque thereof or charge the battery.

When releasing the TCS control according to an exemplary embodiment of the present invention, the motor controller 120 gradually increases the motor torque of the motor 122 such that the vibration of the drive system is reduced.

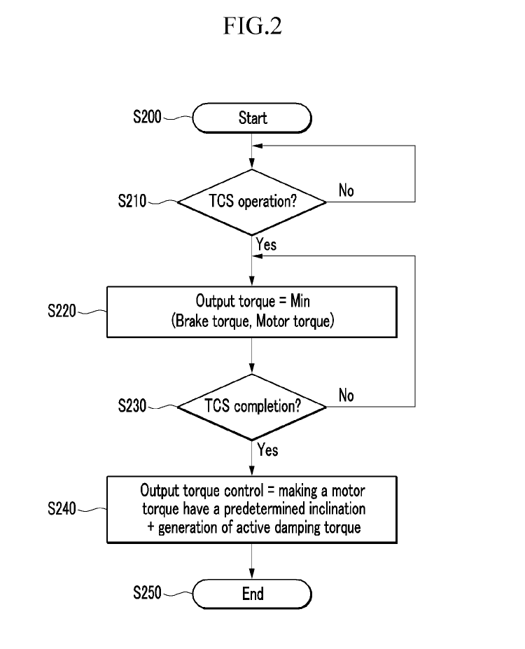

FIG. 2 is a flowchart for controlling a vehicle according to an exemplary embodiment of the present invention.

Referring to FIG. 2, a control starts in step S200 and it is determined whether the TCS control starts or not in a S210. If it is determined that the TCS control is started, the output torque is adjusted in step S220. Here, the brake controller 110 makes the brake 112 outputs a brake demand torque and/or the motor controller 120 controls the motor torque that is outputted from the motor 122 according to a slip of the drive wheel.

If the slip amount of the drive wheel decreases to be within a predetermined value in step S230, it is determined that the TCS control is completed. The output torque of the drive wheel is simultaneously controlled by the brake 112 and the motor 122 in an exemplary embodiment of the present invention.

If it is determined that the TCS control is completed, when the output torque is controlled in step S240, it is controlled such that the motor torque of the motor 122 is changed along a predetermined slope.

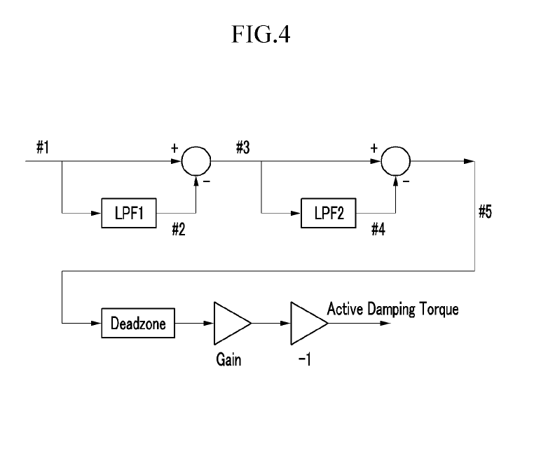

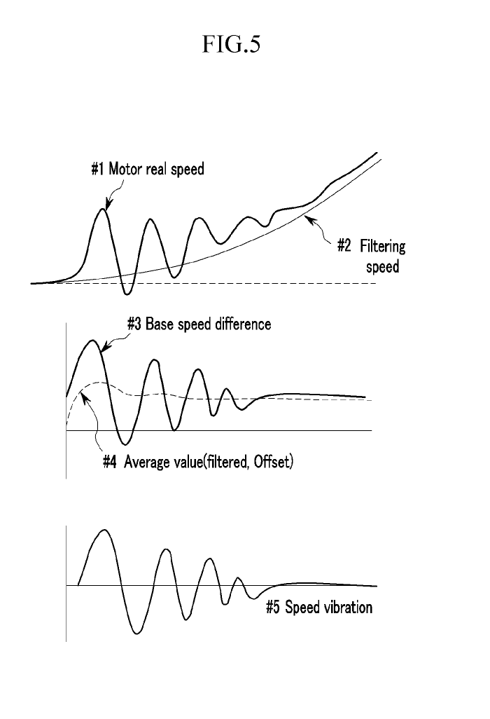

Further, active damping torque may be generated so as to reduce the speed vibration of the motor torque that is outputted from the motor 122. The active damping torque will be hereinafter explained with reference to FIG. 4 and FIG. 5.

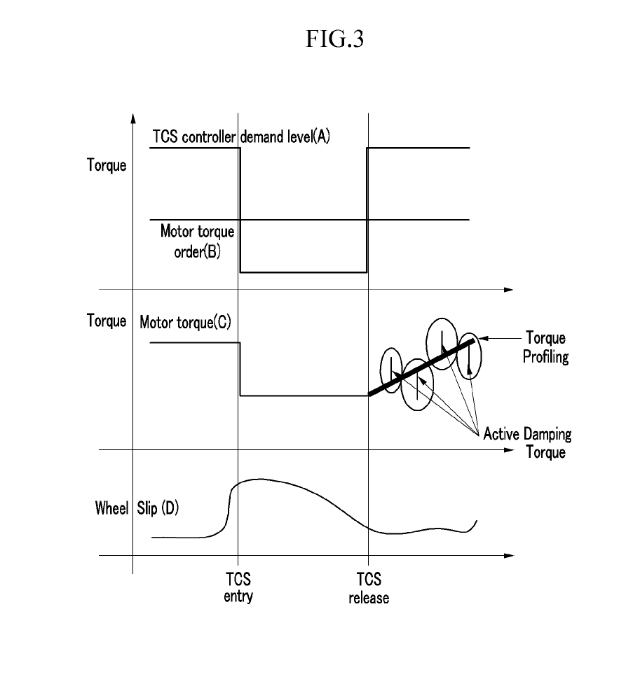

FIG. 3 is a graph for explaining a TCS control of a vehicle according to an exemplary embodiment of the present invention.

Referring to FIG. 3, a horizontal axis denotes a time and a vertical axis denotes a slip amount (wheel slip) of a drive wheel and the motor torque outputted from the motor 122 (TORQUE).

As shown, when the TCS control starts, the demand level (A) of the TCS controller 100 decreases to be a predetermined value and the motor torque (C) of the motor 122 also decreases. In this case, the motor torque order (B) is continuously sustained to operate the motor 122.

If the TCS control starts, the slip amount (D, wheel slip) decrease, and if the slip amount decreases to be lower than a predetermined value, the TCS control is released.

As described above, if the TCS control is released, the demand value (A) of the TCS controller 100 increases to be a predetermined value, and the motor torque (C) of the motor 122 increases.

More particularly, the motor torque (C) slowly increases along a torque profiling line having a predetermined slope. Accordingly, the vibration is reduced, which would have been generated by the abrupt increment of the motor torque (C).

Further, an active damping torque is further generated so as to reduce the speed vibration by the motor torque (C). The active damping torque is a torque that the motor 122 additionally generates by the motor controller 120.

FIG. 4 is a diagram showing a method for extracting a vibration element of a motor in a vehicle according to an exemplary embodiment of the present invention, and FIG. 5 is a graph showing procedures for extracting a speed vibration of a motor in a vehicle according to an exemplary embodiment of the present invention.

Referring to FIG. 4 and FIG. 5, “#1” denotes a real speed of the motor 122, and “#2” denotes a speed line that is calculated by filtering a real speed of the motor 122 through a low-pass filter LPF1. Further, “#3” denotes a speed difference (deviation) between the filtered value and the real speed, and “#4” denotes an average value that is calculated by filtering the speed difference through a second low-pass filter LPF2. Also, “#5” denotes a speed vibration of the motor 122 that is calculated through the speed difference and the average value.

While the speed vibration value is positive, the speed of the motor 122 increases, and while the speed vibration value is negative, the speed of the motor 122 decreases.

Accordingly, the motor controller 120 controls the motor 122 to further generate the active damping torque according to the speed vibration value.

The active damping torque is further generated by the motor 122 in an opposite direction of the speed vibration value, wherein the speed vibration value is minimized by the active damping torque.

An exemplary embodiment of the present invention can be applied to an electric vehicle (EV), a hybrid vehicle (HEV), and a fuel cell vehicle (FCEV).

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims. For instance, it is expressly contemplated that the components and/or elements described herein can be implemented as software being stored on a tangible (non-transitory) computer-readable medium (e.g., disks/CDs/etc.) having program instructions executing on a computer, hardware, firmware, or a combination thereof.

What is claimed is:

1. A vehicle, comprising:
a motor controller configured to control an electric drive motor that transfers a torque to a drive wheel; and
a traction control system (TCS) controller configured to perform a TCS control to i) reduce a torque transferred to the drive wheel such that the drive wheel does not slip when it is determined that the drive wheel slips on the road, and ii) release the TCS control to gradually increase the motor torque transferred to the drive wheel along a predetermine line when it is determined that the drive wheel does not slip on the road.

2. The vehicle of claim 1, further comprising an internal combustion engine configured to selectively transfer a torque to the drive wheel.

3. The vehicle of claim 2, wherein the drive motor is configured to transfer a torque to the drive wheel together with the internal combustion engine.

4. The vehicle of claim 2, further comprising an electricity charged battery, wherein the drive motor is configured to use the electricity of the battery to transfer the torque to the drive wheel.

5. The vehicle of claim 4, wherein the battery is charged by the internal combustion engine.

6. The vehicle of claim 4, wherein the battery is a fuel cell.

7. The vehicle of claim 1, wherein the TCS controller is configured to detect a rotation speed of the motor to calculate a speed vibration while the torque that is transferred from the motor to the drive wheel is increased and wherein the motor controller is configured to make the motor generate an active damping torque in an opposite direction of the speed vibration.

8. A control method for a vehicle, comprising:
determining whether a drive wheel slips;
performing a traction control system (TCS) control in response to determining that the drive wheel slips; and
releasing the TCS control in response to determining that the drive wheel does not slip on the road, while gradually increasing an output torque that is transferred from an electric drive motor to the drive wheel.

9. The control method of a vehicle of claim 8, further comprising:
calculating a speed vibration by using a rotation speed of the motor; and
performing an active damping mode that decreases the speed vibration by forming the output torque of the motor in an opposite direction against the speed vibration.

10. A tangible, non-transitory, computer-readable medium comprising instructions that when executed by a processor are operable to:
determine whether a drive wheel slips;
perform a traction control system (TCS) control in response to determining that the drive wheel slips; and
release the TCS control in response to determining that the drive wheel does not slip on the road, while gradually increasing an output torque that is transferred from an electric drive motor to the drive wheel.

11. The computer-readable medium of claim 10, wherein the instructions when executed are further operable to:
calculate a speed vibration by using a rotation speed of the motor; and
perform an active damping mode that decreases the speed vibration by forming the output torque of the motor in an opposite direction against the speed vibration.
